(19) United States
(12) Patent Application Publication
(10) Pub. No.: US 2026/0311316 A1
(43) Pub. Date: Oct. 8, 2026

(54) METHOD FOR DETERMINING A NEUTRAL FIBRE OF A STRAND OF A WOVEN COMPOSITE MATERIAL

(71) Applicants: SAFRAN, PARIS (FR); SAFRAN AIRCRAFT ENGINES, PARIS (FR)

(72) Inventors: Yanneck WIELHORSKI, MOISSY CRAMAYEL (FR); Arturo MENDOZA QUISPE, MOISSY CRAMAYEL (FR); Hugues TALBOT, CHAMPS SUR MARNE (FR)

(21) Appl. No.: 19/479,155

(22) PCT Filed: Apr. 5, 2024
(86) PCT No.: PCT/FR2024/050453

§ 371 Date: Oct. 27, 2025

(30) Foreign Application Priority Data
Apr. 28, 2023 (FR) FR2304359

(51) Int. Cl. G06T 7/00

(52) U.S. Cl. CPC G06T 7/0004; G06T 2207/10081; G06T 2207/20081; G06T 2207/20084; G06T 2207/30124; G06T 2207/30164

(57) ABSTRACT

A computer-implemented method for determining a neutral fibre of a strand extending in a predetermined direction in a three-dimensional representation of a woven composite material, the three-dimensional representation including a set of two-dimensional slices, the method including obtaining a machine learning model trained to determine, on the basis of the three-dimensional representation of the portion of the part, predictions of positions of centres of sections of strands extending in the predetermined direction in the set of two-dimensional slices; for each two-dimensional slice from among at least one subset of two-dimensional slices: determining, using the obtained machine learning model, a prediction of the position of the centre of the section of the strand and comparing the prediction with a reference position to obtain an indicator of the quality of the prediction; connecting the predictions of the positions to form the neutral fibre of the strand.

### TECHNICAL FIELD OF THE INVENTION

The technical field of the invention is that of woven composite materials and, especially, that of the numerical modelling of these materials.

In particular, the invention relates to a method for determining the skeleton of a strand of woven composite material, providing an quality indicator of said determination. The invention is also directed to a method for training a machine learning model used in said method for determining the skeleton of a strand of woven composite material.

### TECHNOLOGICAL BACKGROUND OF THE INVENTION

A woven composite material is an assembly including at least one woven textile framework referred to as a reinforcement and a binder referred to as a matrix. The reinforcement is the armature bearing most of the mechanical forces. The purpose of the matrix is to transmit mechanical forces to the reinforcement, to protect it and to hold it in place within the part.

The reinforcement comprises strands (also referred to as “yarns”) woven using a weaving machine, according to a theoretical weaving topology. The weaving topology is defined in at least two orientations, also called reinforcement axes, each strand comprising a plurality of fibres, often of carbon or glass. The reinforcement axes are conventionally referred to as “warp” and “weft”. In general, the warp corresponds to the main weaving direction, and the weft corresponds to the transverse direction, orthogonal to the warp. The way in which the strands are interlaced (i.e. the pattern according to which the strands are woven) is conventionally referred to as “weave”.

The different strand arrangements are designed and optimised for the expected mechanical loads. It is therefore important to be able to reconstruct the textile model of a woven material, especially to control quality of its manufacture, but also for detection of any deterioration during use, for example in the case of a mechanical part, such as an aeronautical part, subjected to significant mechanical loads.

Conventionally, a textile model includes a parametric description of each strand within a weave. By “parametric description of a strand”, it is meant here a description of a strand as a solid object, characterized by a neutral fibre and transverse cross-sections associated with at least some points of the neutral fibre.

By “neutral fibre” or “skeleton”, it is meant a curve describing the central path of the strand in space. Transverse cross-sections are two-dimensional curves defined on planes orthogonal to the tangent of the neutral fibre. An example of a parametric description of a strand is represented in FIG. 1. Here, the neutral fibre is represented by the ordered series of points connected by the solid line. The ellipses represent the transverse cross-sections of the parametric representation of the strand. Textile modelling using the strand as the most elementary unit is also referred to as mesoscopic textile modelling.

There are methods for determining the textile model of a composite material part (or portion of a part) from a 3D tomographic image of that part. An example of a tomographic image of such a woven material is represented in FIG. 2 (adapted from the article “Descriptive modelling of textiles using FE simulations and deep learning” by A. Mendoza, R. Trullo and Y. Wielhorski, published in the journal “Composites Science and Technology” in 2021). One such method relies on the manual extraction of neutral fibres and transverse cross-sections by expert operators.

This manual approach to textile model extraction begins with manually locating the neutral fibres of all the strands present within a region of interest in the woven composite material. It is important to note that this manual location step is very time-consuming. Next, one or more transverse cross-sections are assigned to the neutral fibre in order to obtain a solid object for each strand. In general, an idealised parameter transverse cross-section (for example, an ellipse) is assigned to each orientation (warp and weft). This step therefore does not require the intervention of an expert operator for each strand or for each important point (for example: a point associated with a change in curvature) of the strand. Thus, it is the step of manually locating the neutral fibres that is essential in the manual approach to textile model extraction.

The procedure for manually locating a strand j in the region of interest is detailed in FIG. 3. The first step comprises identifying the planes of interest for strand j, represented by the vertical dotted lines. This location is made on a two-dimensional image or two-dimensional cross-section representing the strand in its length, such as the one represented on the left. In this case, it is a cross-section along the xz plane, on which the coordinates xⱼⁱ have been determined along the axis x of the centres of the neutral fibre at the planes of interest, each value xⱼⁱ corresponding to the coordinate along the axis x of the centre of the neutral fibre associated with strand j at plane i. The other two coordinates of the neutral fibre centres at the planes of interest, namely (yⱼⁱ, zⱼⁱ), are then identified on a cross-section xy corresponding to the plane of interest i (illustrated on the right in FIG. 3). These two steps make it possible to identify all the points of the neutral fibre associated with the strand and corresponding to the planes of interest. The planes of interest are generally set by the operator as a function of the intersections (of strands in the orthogonal direction) that the strand has along its length or by its inflection points.

Next, interpolation functions (for example: splines or radial basis functions) are used to connect the identified points in order to obtain the skeleton associated with the strand. A respective 3D curve is thus obtained for each strand. However, a comparison between the curve obtained and several two-dimensional views is necessary to verify quality of the modelling obtained. If the skeleton thus obtained does not represent the strand of interest accurately enough, it is necessary to repeat the method by adding additional planes of interest.

This manual location method must be performed for each strand in the region of interest, which makes manual extraction of the textile model particularly time-consuming and costly. In addition, the results can be highly operator-dependent, which limits reproducibility and reliability of the manual extraction.

Recently, some methods for automatic or semi-automatic extraction of the textile model have been provided. These methods rely on image processing techniques, for example to identify regions of the volume belonging to each of the components of the woven material or to identify key points for defining the strands.

Most of these methods resort to structural tensors to extract local orientation information. These signatures are then processed either by ad hoc algorithms constructed on the basis of machine-specific heuristics (see, for example, the scientific article “3D composite reinforcement meso F.E. analyses based on X-ray computed tomography” published in “Composite Structures” in 2015), or by algorithms based on statistical analysis of data (see, for example, the scientific article “Quantification of the internal structure and automatic generation of voxel models of textile composites from X-ray computed tomography data” by I. Straumit et al., published in “Composites Part A: Applied Science and Manufacturing” in 2015). It has also been suggested processing these signatures using deep learning algorithms (see, for example, “Descriptive modelling of textiles using FE simulations and deep learning” by A. Mendoza et al., published in “Composites Science and Technology” in 2021).

However, each of these methods has been developed for a specific strand crossing pattern and is not generally applicable. Further, these methods are often not very robust to errors (they tend to propagate centre positioning errors from one cross-section to another) and do not have any means of monitoring such errors. There is therefore a need today to develop a method for extracting a textile model that is at least partially automatic while remaining reliable, reproducible and applicable to a wide variety of composite woven materials.

### SUMMARY OF THE INVENTION

The invention offers a solution to the problems discussed previously by determining a three-dimensional representation of the skeleton of a strand of woven material, while also providing an indication regarding the quality (or reliability) of the representation. Manual intervention by an operator can therefore be limited to those strand regions in which automatic reconstruction of the skeleton is not sufficiently reliable. By virtue of the invention, the reconstruction of a strand skeleton is carried out at least partially automatically, and the time required for an operator to verify (and possibly correct) an automatic reconstruction of a strand is thus advantageously reduced.

A first aspect of the invention thus relates to a computer-implemented method for determining a skeleton of a strand extending in a predetermined direction in a three-dimensional representation of a portion of a woven composite material part, the three-dimensional representation of the portion of the part comprising a set of two-dimensional cross-sections, the two-dimensional cross-sections extending in a plane normal to the predetermined direction and comprising successive sections of the strand, said method comprising:
Obtaining a machine learning model trained to determine, from the three-dimensional representation of the portion of the part, predictions of positions of centres of sections of strands extending along the predetermined direction in the set of two-dimensional cross-sections;
For each two-dimensional cross-section among a subset of two-dimensional cross-sections:
   Determining, using the machine learning model obtained, a prediction of the position of the strand section centre in said two-dimensional cross-section; and
   Comparing the prediction of the position of the strand section centre to a reference position of the strand section centre to obtain a quality indicator of the prediction of the position of the strand section centre in the cross-section;
For each cross-section for which the quality indicator associated with the predicted position does not meet a predetermined quality criterion, correcting the predicted position by assigning it the reference position; and
Connecting the predictions of the positions of the strand section centres to form the strand skeleton.

By “strand”, it i meant an assembly of one or more fibre bundles (also known as plies). The fibre bundles are often twisted between each other to improve cohesion of the strand. The strand extends along a predetermined direction, for example a warp or weft direction.

By “skeleton”, it is meant a parametric model of a strand comprising a series of spatial coordinates of strand section centres. The strand skeleton (also referred to as the “neutral fibre”) typically represents the path of the strand centre in the three-dimensional representation.

By “three-dimensional representation of a portion of a woven material part”, it is meant a representation obtained by virtue of imaging methods allowing for non-destructive observation inside the woven material. Tomographic images are an example of three-dimensional representation. The three-dimensional representation may typically comprise a plurality of voxels, each voxel being associated with a respective grey level.

By “two-dimensional cross-section”, it is meant a two-dimensional image of the woven material extracted from the three-dimensional representation. For example, a two-dimensional cross-section may be a cross-section of a three-dimensional image with a thickness of 1 voxel.

By “quality” of the prediction of the position of the strand section centre, it is meant a measurement of the reliability (or accuracy) of said three-dimensional representation obtained by comparing the prediction of the position with a reference position. In other words, the quality indicator of the prediction of the position of the strand section centre in the cross-section provides a confidence measurement in the reliability of the prediction performed.

By “reference position of the strand section centre”, it is meant a value of the section centre position against which the predicted position is compared. This reference position can be set manually by an operator, for example on the first two-dimensional cross-section in the series of two-dimensional cross-sections, or it can be derived from a prediction performed on a reference two-dimensional cross-section.

The reference two-dimensional cross-section may, especially, be a “close” (i.e. meeting a predefined distance criterion) two-dimensional cross-section, according to the orientation of the strand, of the two-dimensional cross-section for which the prediction of the strand centre position is calculated (referred to as the “current” cross-section). For example, the reference two-dimensional cross-section is a two-dimensional cross-section analysed before the current two-dimensional cross-section giving the prediction of the position of the strand skeleton. The reference cross-section, for a prediction performed at the plane of interest i, may, for example, be a cross-section corresponding to the plane of interest i-1. This makes it possible to evaluate whether the prediction of the position of the strand section centre excessively deviates from the preceding prediction and, if necessary, to draw an operator's attention to this region of the strand parametric representation. The two “close” cross-sections i and i-1 are, for example, separated by a distance of less than 100 μm, corresponding to about 5 voxels. According to one embodiment, cross-sections i and i-1 are separated by a distance corresponding to 1 voxel.

The above method uses a machine learning model to extract a representation of a strand in the form of a skeleton while providing an indication regarding quality of said representation.

In addition, the indication regarding quality of the representation is provided for each point of the strand skeleton. This makes it possible to directly identify the regions of the strand parametric representation that require operator intervention.

The step of comparing the prediction of the strand section centre with a reference position allows to make “step by step tracking”. Indeed, this step consists in comparing the result of the segmentation of a two-dimensional cross-section with the positions of the centres identified for a reference cross-section, for example the preceding cross-section. This involves initialisation of the points in any image. This initialisation can be made manually by the operator, for example by identifying the centres of the strands of interest. This has the advantage that the operator can select the strands of interest that will be part of the textile model and, a fortiori, those that will be excluded therefrom. Thus, the method according to the first aspect of the invention allows the known points to be propagated from one two-dimensional cross-section to another until the last available section is reached.

To obtain a complete textile model, the method according to the first aspect of the invention must be made on both strand orientations. It is important to note that the tracking must be part of an approach for characterising quality of the prediction while ensuring a “correct” determination of the neutral fibres (soft, regular, without discontinuities and respecting the weaving pattern).

By virtue of the method according to the first aspect of the invention, the time required to extract a theoretical model of the woven composite material is greatly reduced. Additionally, the model obtained is more reliable and reproducible because it requires very limited intervention by an operator.

In one or more embodiments, the three-dimensional representation is obtained by tomography. For example, the three-dimensional representation can be obtained by X-ray tomography.

In one or more embodiments, the woven composite material part is an aeronautical part such as an engine blade.

In one or more embodiments, the quality indicator for the prediction of the position of the strand section centre in the cross-section is a function of the difference between the prediction of the position of the strand section centre and the reference position of the strand section centre.

In one or more embodiments, the predetermined quality criterion comprises defining a neighbourhood around the reference position, the predetermined quality criterion being satisfied if the prediction of the position determined using the machine learning model belongs to the neighbourhood.

In one or more embodiments, the method according to the first aspect of the invention further comprises receiving, for at least one two-dimensional cross-section among the set of two-dimensional cross-sections, a set of verified positions of strand section centres, the reference position of the strand section centre belonging to said set of verified positions of strand section centres.

A verified position is understood to be a position annotated by hand or verified by an operator. The two-dimensional cross-section with verified positions may be the first cross-section in the sequence of two-dimensional cross-sections, so as to initialise the initial position of the strand skeleton. In another example, other two-dimensional cross-sections annotated may be received, these cross-sections being distant from the first cross-section, so as to use reference positions verified by an operator during the reconstruction of the strand skeleton.

In one or more embodiments, the reference position of the strand section centre corresponds to the position of the strand section centre predicted by the model in another two-dimensional cross-section of the subset of two-dimensional cross-sections.

In one or more embodiments:
the two-dimensional cross-sections of the three-dimensional image are successive sections indexed cross-sections along the predetermined direction, each cross-section being associated with a respective value with an index i;
the reference position corresponds to the position of the strand cross-section centre predicted by the model in a reference cross-section with index i_{R};
the absolute value of the difference between i_{R} and i_{C} is less than a predetermined value, i_{C} being the index of the cross-section at which the position of the strand section centre is determined.

In one or more embodiments, the method according to the first aspect of the invention further comprises obtaining, from the quality indicators determined, an overall quality indicator for the determination of the strand skeleton.

In one or more embodiments, the overall quality indicator is obtained from the percentage of predictions satisfying a predetermined quality criterion or from a linear combination of quality indicators.

In one or more embodiments, the method according to the first aspect of the invention further comprises issuing a message indicating that the strand skeleton must be verified by an operator if the overall quality indicator does not meet a given criterion.

In one or more embodiments, the machine learning model is trained according to a training method comprising:
Receiving a plurality of three-dimensional representations of a respective plurality of portions of woven composite material part, each three-dimensional representation comprising a respective set of two-dimensional cross-sections, the two-dimensional cross-sections extending in a plane normal to the predetermined direction and representing sections of strands extending along the predetermined direction, the two-dimensional cross-sections being annotated with a set of positions corresponding to section centres of strands extending along the predetermined direction;
Training the machine learning model using the two-dimensional cross-sections annotated, the trained machine learning model taking a two-dimensional cross-section as an input and being configured to output a prediction of the positions of the strand centres in said two-dimensional cross-section, the training being performed by optimising a cost function dependent on a difference between predicted positions and positions of the two-dimensional cross-section annotated.

Such a training method makes it possible to train a machine learning model configured to provide a prediction of the position of a strand section centre. To do this, training the machine learning model is performed from using a suitably established database. This database comprises two-dimensional cross-sections annotated, in which the parametric properties of interest have been identified by an operator.

In other words, the machine learning model trained in accordance with the second aspect of the invention enables the efficient segmentation of images representing two-dimensional cross-sections of woven composite materials in order to extract strand section centres therefrom.

In one or more embodiments, the machine learning model is a neural network.

Another aspect of the invention is directed to a device for determining a skeleton of a strand extending in a predetermined direction in a three-dimensional representation of a portion of a woven composite material part, the three-dimensional representation of the portion of the part comprising a set of two-dimensional cross-sections, the two-dimensional cross-sections extending along a plane normal to the predetermined direction and comprising successive sections of the strand, said device comprising:
an input interface to obtain a machine learning model trained to determine, from the three-dimensional representation of the portion of the part, predictions of positions of centres of sections of strands extending along the predetermined direction in the set of two-dimensional cross-sections;
a circuit configured to:
   for each two-dimensional cross-section among a subset of two-dimensional cross-sections:
      determine, using the machine learning model obtained, a prediction of the position of the strand section centre in said two-dimensional cross-section; and
      compare the prediction of the position of the strand section centre with a reference position of the strand section centre to obtain a quality indicator of the prediction of the position of the strand section centre in the cross-section;
   for each cross-section for which the quality indicator associated with the predicted position does not meet a predetermined quality criterion, correct the predicted position by assigning it the reference position; and
   connect the predictions of the positions of the strand section centres to form the strand skeleton.

According to one embodiment, if the quality indicator for predicting the position of the centre of the strand in the cross-section does not meet a predetermined criterion, the prediction of the position of the centre of the strand in the cross-section is replaced with the reference position.

A fourth aspect of the invention relates to a device for training a machine learning model to determine a skeleton of a strand extending in a predetermined direction in a portion of a woven composite material part, the device comprising:
An input interface to receive a plurality of three-dimensional representations of a respective plurality of portions of woven composite material, each three-dimensional representation comprising a respective set of two-dimensional cross-sections, the two-dimensional cross-sections extending in a plane normal to the predetermined direction and representing sections of strands extending along the predetermined direction, the two-dimensional cross-sections being annotated with a set of positions corresponding to section centres of strands extending along the predetermined direction;
A circuit to train the machine learning model using the two-dimensional cross-sections annotated, the trained machine learning model taking a two-dimensional cross-section as an input and being configured to output a prediction of the positions of the strand centres in said two-dimensional cross-section, the training being performed by optimising a cost function dependent on a difference between predicted positions and positions of the two-dimensional cross-section annotated.

A fifth aspect of the invention is directed to a computer program product including instructions for implementing the method according to the first aspect of the invention when the program is executed by a processor.

The invention and its different applications will be better understood upon reading the following description and upon examining the accompanying figures.

### BRIEF DESCRIPTION OF THE FIGURES

Other characteristics and advantages of the invention will become apparent upon reading the description, which may be read in conjunction with the figures. These figures are set forth by way of indicating and in no way limiting purposes of the invention.

FIG. 1 schematically represents a parametric representation of a strand.

FIG. 2 represents a tomographic image of a woven composite material.

FIG. 3 schematically represents the method for manually extracting a textile model according to the state of the art.

FIG. 4 represents a flowchart of a method for training a machine learning model to determine a representation of a strand skeleton according to one embodiment of the invention.

FIG. 5 represents a flowchart of a method for determining a representation of a strand skeleton according to one embodiment of the invention.

FIG. 6a represents an example of a two-dimensional cross-section extracted from a three-dimensional representation of a woven composite material.

FIG. 6b represents the result of applying the machine learning model according to the second aspect of the invention to the two-dimensional cross-section illustrated in FIG. 6a.

FIG. 7a illustrates a step of comparing predictions of positions of strand section centres between reference positions.

FIG. 7b, FIG. 7c FIGS. 7b and 7c represent strand position predictions associated with different quality indicators.

FIG. 8 represents a strand skeleton obtained using the method according to the first aspect of the invention.

### DETAILED DESCRIPTION

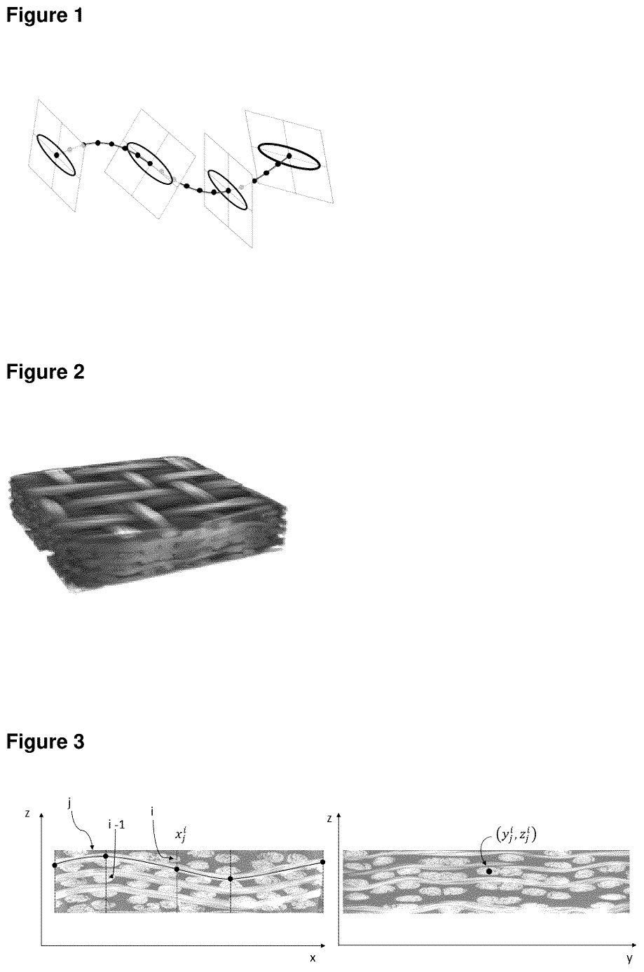

FIGS. 1, 2 and 3 have been described in relation to the state of the art.

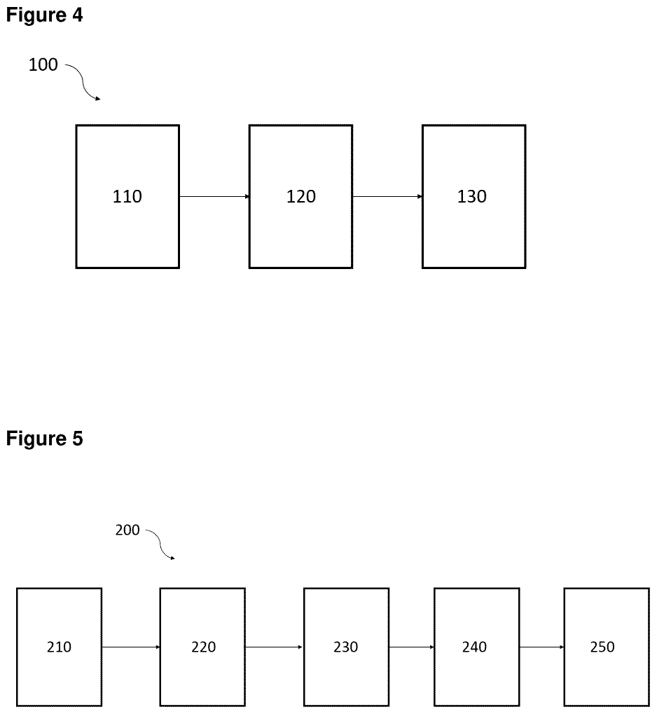

FIG. 4 shows a flowchart of an embodiment of method 100 for training a machine learning model to determine a strand skeleton according to the second aspect of the invention. The method 100 is implemented by a computer.

The method 100 according to the embodiment illustrated in FIG. 4 comprises a step 110 of receiving a plurality of three-dimensional representations of a respective plurality of portions of woven composite material parts. The three-dimensional representations may, for example, be tomographic images of woven composite material parts. Each three-dimensional representation comprises a set of two-dimensional cross-sections. The plane of the two-dimensional cross-sections is normal to the direction along which the strand whose skeleton is intended to be determined extends, so as to show sections of strands. The images have been previously annotated, for example to identify the centres of sections of strands extending along the predetermined direction.

The set of two-dimensional cross-sections annotated therefore represents the database for training the machine learning model, which is performed in step 120. Training is made by optimising a cost function that evaluates the difference between the predicted positions and the annotated positions in the database.

The model thus trained is configured to take a two-dimensional cross-section as an input and output a prediction of the positions of the strand centres in said two-dimensional cross-section.

The method 100 may also include a step 130 of issuing predictions of the positions of the strand centres in the cross-section analysed.

The machine learning model is, according to one embodiment, a neural network. For example, the neural network is of the convolutional neural network type or the U-Net type.

FIG. 5 illustrates a flowchart of an embodiment of the method 200 for determining a skeleton of a strand extending in a predetermined direction according to the first aspect of the invention. The skeleton of the strand is determined from a three-dimensional representation of the woven composite material comprising the strand. The three-dimensional representation may, for example, be a tomographic image of a portion of the woven composite material.

The three-dimensional representation comprises a set of two-dimensional cross-sections whose plane is normal to the direction along which the strand extends. The set of two-dimensional cross-sections comprises successive sections of the strand whose skeleton is intended to be determined.

The method 200 according to the embodiment illustrated in FIG. 5 comprises a step 210 of obtaining a machine learning model trained to determine predictions of positions of centres of sections of strands extending along the predetermined direction. The machine learning model may, for example, be trained in accordance with the method 100 according to the second aspect of the invention.

The method 200 according to the embodiment illustrated in FIG. 5 comprises a step 220 of determining a prediction of the position of the strand section centre for each two-dimensional cross-section analysed. The prediction is provided by the machine learning model obtained in step 210.

The prediction obtained in step 220 is then compared to a reference position in step 230. It is then possible to obtain a quality indicator for the prediction of the position of the strand section centre in the cross-section. The reference position may be a manually determined reference position or even a prediction performed in another two-dimensional cross-section. For example, the reference value may be a prediction of the position of the strand section centre performed from a cross-section adjacent to the cross-section analysed.

According to one embodiment, the prediction quality indicator is a function of the distance between the predicted position and the reference position.

If the quality indicator meets a predetermined quality criterion, the position is considered to be correctly predicted or the prediction is considered to be of good quality.

Conversely, if the quality indicator does not meet the predetermined quality criterion, the prediction is considered incorrect (or the reliability of the prediction is too low). In this case, a correction to the prediction is implemented, during which the predicted position is replaced with the reference position.

This makes it possible to discard predictions whose value differs too much from the reference value, which are ‘aberrant’ predictions, and replace them with “correct” positions (in the case where manual annotation is used) or “more probable” positions (in the case where a prediction from a neighbouring cross-section is used indeed, the positions in two neighbouring cross-sections are unlikely to be too far apart).

The method 200 according to the first aspect of the invention comprises a step 240 of connecting the predictions of the positions of the strand section centres. This step makes it possible to obtain the skeleton of the strand.

In an optional step 250, the quality indicators determined for the different cross-sections in step 230 are used to provide an overall quality indicator of the determination of the strand skeleton. This allows the quality of the reconstruction of the strand skeleton to be quickly evaluated. For example, the overall quality indicator of the strand skeleton determination may be a linear combination of the “local” indicators determined for the different cross-sections. In one embodiment, the weights may be the same for all local indicators. Alternatively, different weights may be assigned to the local indicators.

For example, a global indicator I1 is obtained as a percentage of “good predictions” out of the set of predictions. A “good prediction” is understood to be a prediction whose quality indicator meets a predetermined criterion, for example a criterion of distance between the prediction and the reference position. In this case, all points have the same weight. This gives a value per strand, i.e. an indicator that reflects only the percentage of good detections.

According to another example, a global indicator I2 may include the density or spatial distribution of good predictions. The density of good predictions can be defined locally, where the strand is broken down into segments of identical or different sizes. The global indicator I2 can then be calculated as a linear combination of the values of the local density indicator weighted by the size of the segment. Indeed, there is a difference in the ease of reconstructing the strand depending on whether the error is evenly distributed across the entire strand skeleton or concentrated in a very specific zone. In the first case, smoothing the points may be conclusive without the need for manual modifications. In the second case, however, it will be necessary to reconstruct an entire zone of the strand skeleton.

According to another example, a global indicator I3 can be obtained as the product of global indicators I1 and I2, I3=I1*I2.

According to one embodiment of step 250 of the method 200, the overall quality indicator expresses the percentage of correct predictions out of all the predictions of section centre positions used to determine the strand skeleton.

According to one embodiment of the method 200 according to the first aspect of the invention, the method 200 further comprises a step of receiving a set of verified positions of strand section centres, for example by an operator. The reference value can then be selected from among these manually verified positions. For example, for a current cross-section, the positions predicted by the model are compared to the verified positions of the same current cross-section.

According to one embodiment of the method 200 according to the first aspect of the invention, the set of two-dimensional cross-sections to be analysed for the reconstruction of the strand skeleton is a set of successive indexed cross-sections in the predetermined direction. Each cross-section is then associated with a value with an index i, which in turn is linked to the position of the cross-section in the three-dimensional representation of the woven composite material.

According to one embodiment, the reference position is a prediction of the section centre position obtained from a cross-section with index i_{R} and the prediction of the section centre position is obtained from a cross-section with index i_{C}. The absolute value of the difference between i_{R} and i_{C} is then less than a predetermined value. This makes it possible to use a reference position that is sufficiently “close” to the cross-section analysed and to effectively make step by step tracking of the strand skeleton.

For example, if the reference cross-section is the cross-section adjacent to the cross-section analysed, the absolute value of the difference between i_{R} and i_{C} is equal to 1.

According to one embodiment, the method 200 according to the invention may further comprise a step of issuing a message indicating that the strand skeleton must be checked by an operator. Such a message is triggered, for example, if the overall quality indicator does not meet a given criterion. For example, the message is sent when the percentage of correctly predicted positions among the points forming the strand skeleton is less than a predefined threshold value, for example 50%.

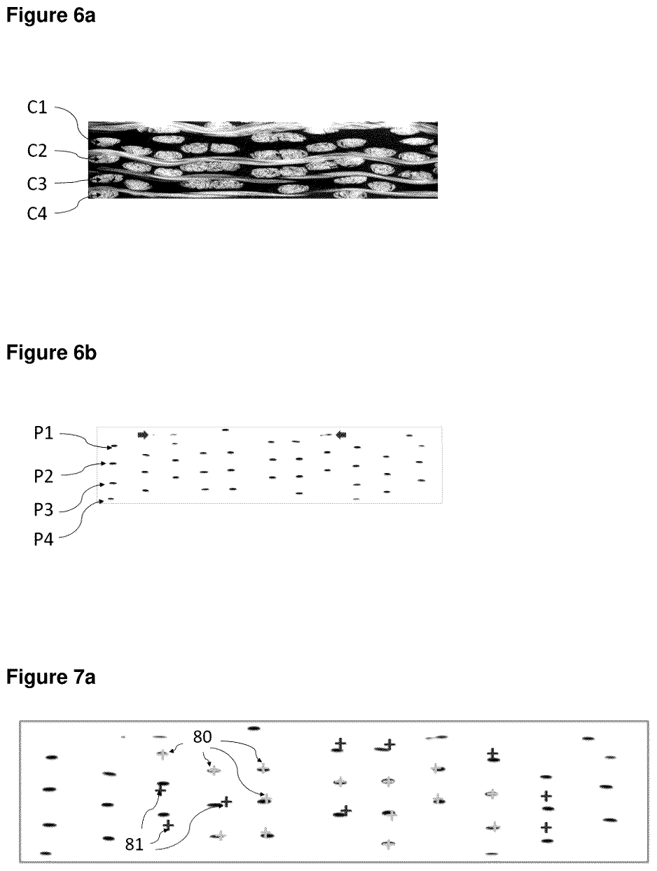

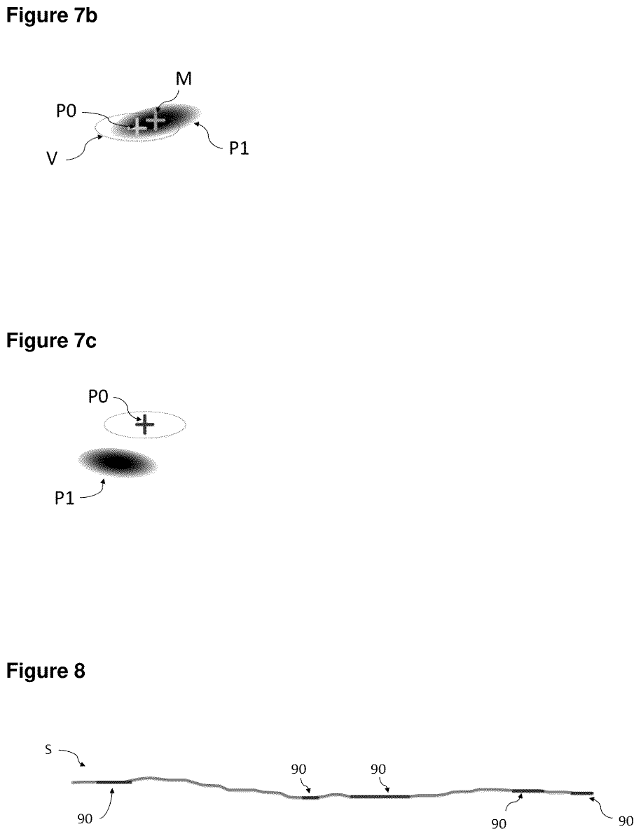

FIG. 6a illustrates an example of a two-dimensional cross-section extracted from a tomographic image of a woven composite material. Several sections of strands extending along the direction normal to the image plane are visible, for example sections C1, C2, C3 and C4. The machine learning model according to the first aspect of the invention is trained to take as an input an image such as that in FIG. 6a and output an image such as that illustrated in FIG. 6b, in which the predictions of the strand section centres are indicated. In this case, predictions P1, P2, P3 and P4 correspond to the centres of sections C1, C2, C3 and C4 in FIG. 7a. The two arrows in FIG. 6b illustrate examples of errors in the analysis or segmentation of the image. For example, the arrow on the left indicates a redundancy in the detection of a strand in the image. Indeed, the strand in this section has a more splitted shape than the others and misled the network by detecting the same strand twice.

FIG. 7a shows the result of a step of comparison between the predicted positions of the section centres, represented by the positions of the grey-scale spot maxima, and the reference positions obtained in a preceding cross-section, represented by crosses. The quality of the prediction can be determined based on the distance between the predicted position and the reference position. The grey crosses 80 in FIG. 7a represent good-quality predictions, namely predictions that meet a predetermined quality criterion. The black crosses 81 represent poor-quality predictions, i.e. positions that do not meet the predetermined quality criterion.

FIGS. 7b and 7c represent examples of criteria for determining whether a prediction of the position of the strand section centre is of good or poor quality. These criteria are also referred to as heuristics.

FIG. 7b illustrates a case of good quality P1 prediction. For the position identified in the preceding two-dimensional view or reference position, P0, an ellipsoidal search neighbourhood V is defined according to the ratio of the cross-section of the strand. Any locally maximum point M in the probability map within this neighbourhood becomes a candidate for the new point in the current two-dimensional view. In other words, point M is the prediction of the position of the strand centre obtained on the current cross-section. Point M can be determined as the local maximum from the prediction.

The neighbourhood V is defined as an elliptical surface because, overall, the sections of the strands in an image have this shape. The minor and major axes can be determined according to the linear density of the strands, which can vary in size depending on the number of filaments composing them and their level of compaction. The ellipses can therefore be of different sizes depending on the size of the strands to be detected.

These distance calculations can be made using a Euclidean distance weighted by the transverse cross-sectional ratio in order to properly weight the segmentation error. In other words, the terms in the Euclidean distance calculation can be weighted according to the length of the minor axis and the length of the major axis of the ellipse representing the neighbourhood V. Then, since several candidates may remain within a given neighbourhood, another heuristic can be used to select one: select the candidate closest to the analysed point if and only if it is not the closest candidate for another neighbourhood with a shorter distance. However, if several candidates are possible, one could be randomly selected.

Conversely, FIG. 7c shows the case where prediction P1 is of poor quality. In this case, it is possible to define as the current point of the skeleton the point of the current section that has the same position as the known point of the preceding view P0. In other words, the position of point PO becomes the strand section centre in the next cross-section. It is important to note that this tracking approach ensures that any point identified by the operator will be propagated across all two-dimensional views while respecting the topology of the weave. Indeed, the set of heuristics described previously makes it virtually impossible to assign a point to a strand that does not correspond thereto (due to non-compliance with the topology).

FIG. 8 illustrates an example of a skeleton S determined using method 200 according to the first aspect of the invention. The lines 90 correspond to portions of the skeleton that have not been reconstructed accurately enough (i.e. for which the quality indicators were below the predefined threshold, and for which the current positions have been estimated from the preceding positions of the centre). In other words, each point on the skeleton belonging to a line 90 corresponds to a situation such as that represented in FIG. 7c. These lines are straight line segments because each position is identical to the preceding position.

Indeed, by virtue of method 200 according to the first aspect of the invention, each point belonging to the skeleton of a strand is categorised as either well identified or not. In the first case, the position of the point is defined as the prediction of the position provided by the machine learning model obtained in step 210. In the second case, the tracking algorithm defines the position of the point by keeping the position obtained during the analysis of a preceding image. Thus, an overall indicator per strand can be defined as the percentage of well-segmented points (along the strand). For example, FIG. 8 shows a strand skeleton S with 65% of points well-segmented out of a total of 308 points. The value of the overall quality indicator associated with skeleton S is therefore 65%.

1. A computer implemented method for determining a skeleton of a strand extending in a predetermined direction in a three-dimensional representation of a portion of a woven composite material part, the three-dimensional representation of the portion of the part comprising a set of two-dimensional cross-sections, the two-dimensional cross-sections extending in a plane normal to the predetermined direction and comprising successive sections of the strand, said method comprising:
obtaining a machine learning model trained to determine, from the three-dimensional representation of the portion of the part, predictions of positions of centres of sections of strands extending along the predetermined direction in the set of two-dimensional cross-sections;
for each two-dimensional cross-section among a subset of two-dimensional cross-sections:
determining, using the machine learning model obtained, a prediction of the position of the strand section centre in said two-dimensional cross-section; and
comparing the prediction of the position of the strand section centre with a reference position of the strand section centre to obtain a quality indicator of the prediction of the position of the strand section centre in the cross-section;
for each cross-section for which the quality indicator associated with the predicted position does not meet a predetermined quality criterion, correcting the predicted position by assigning it the reference position; and
connecting the predictions of the positions of the strand section centres to form the strand skeleton.

2. The method according to claim 1, wherein the three-dimensional representation is obtained by tomography.

3. The method according to claim 1, wherein the woven composite material part is an aeronautical part.

4. The method according to claim 1, wherein the quality indicator for the prediction of the position of the strand section centre in the cross-section is a function of the difference between the prediction of the position of the strand section centre and the reference position of the strand section centre.

5. The method according to claim 1, wherein the predetermined quality criterion comprises defining a neighbourhood around the reference position, the predetermined quality criterion being satisfied if the prediction of the position determined using the machine learning model belongs to the neighbourhood.

6. The method according to claim 1, further comprising: receiving, for at least one two-dimensional cross-section among the set of two-dimensional cross-sections, a set of verified positions of strand section centres, the reference position of the strand section centre belonging to said set of verified positions of strand section centres.

7. The method according to claim 1, wherein the reference position of the strand section centre corresponds to the position of the strand section centre predicted by the model in another two-dimensional cross-section of the subset of two-dimensional cross-sections.

8. The method according to claim 7, wherein:
the two-dimensional cross-sections of the three-dimensional representation are successive indexed cross-sections along the predetermined direction, each cross-section being associated with a respective value with an index i_{R};
the reference position corresponds to the position of the strand section centre predicted by the model in a reference cross-section with index i_{R};
the absolute value of the difference between i_{R} and i_{C} is less than a predetermined value, i_{C} being the index of the cross-section at which the position of the strand section centre has been determined.

9. The method according to claim 1, further comprising obtaining, from the quality indicators determined, an overall quality indicator for the determination of the strand skeleton, wherein the overall quality indicator is obtained from the percentage of predictions satisfying a predetermined quality criterion or from a linear combination of quality indicators.

10. The method according to claim 1, wherein the machine learning model is trained according to a training method comprising:
receiving a plurality of three-dimensional representations of a respective plurality of portions of woven composite material part, each three-dimensional representation comprising a respective set of two-dimensional cross-sections, the two-dimensional cross-sections extending in a plane normal to the predetermined direction and representing sections of strands extending along the predetermined direction, the two-dimensional cross-sections being annotated with a set of positions corresponding to section centres of strands extending along the predetermined direction;
training the machine learning model using the two-dimensional cross-sections annotated, the trained machine learning model taking a two-dimensional cross-section as an input and being configured to output a prediction of the positions of the strand centres in said two-dimensional cross-section, the training being performed by optimising a cost function dependent on a difference between predicted positions and positions of the two-dimensional cross-section annotated.

11. A device for determining a skeleton of a strand extending in a predetermined direction in a three-dimensional representation of a portion of a woven composite material part, the three-dimensional representation of the portion of the part comprising a set of two-dimensional cross-sections, the two-dimensional cross-sections extending in a plane normal to the predetermined direction and comprising successive sections of the strand, said device comprising:
an input interface to obtain a machine learning model trained to determine, from the three-dimensional representation of the portion of the part, predictions of positions of centres of sections of strands extending along the predetermined direction in the set of two-dimensional cross-sections;
a circuit configured to:
for each two-dimensional cross-section among a subset of two-dimensional cross-sections:
determine, using the machine learning model obtained, a prediction of the position of the strand section centre in said two-dimensional cross-section; and
compare the prediction of the position of the strand section centre with a reference position of the strand section centre to obtain a quality indicator of the prediction of the position of the strand section centre in the cross-section;
for each cross-section for which the quality indicator associated with the predicted position does not meet a predetermined quality criterion, correct the predicted position by assigning it the reference position; and
connect the predictions of the positions of the strand section centres to form the strand skeleton.

12. A non-transitory computer readable medium including instructions for implementing the method according to claim 1 when the instructions are executed by a processor.
